(19) United States
(12) Patent Application Publication
(10) Pub. No.: US 2018/0169786 A1
(43) Pub. Date: Jun. 21, 2018

(54) METHOD FOR MANUFACTURING METAL STRIP

(71) Applicant: METAL INDUSTRIES RESEARCH & DEVELOPMENT CENTRE, Kaohsiung City 811 (TW)

(72) Inventors: Kuan-Yu Chen, Kaohsiung City (TW); Lung-Tien Wu, Kaohsiung City (TW); Chun-Chieh Wang, Kaohsiung City (TW); Chia-Min Wei, Tainan City (TW); Chun-Lin Yeh, Tainan City (TW)

(21) Appl. No.: 15/379,671

(22) Filed: Dec. 15, 2016

(51) Int. Cl. B23K 26/06; G01N 21/956; B23K 26/03; B23K 26/26; B23K 26/70

(52) U.S. Cl. CPC B23K 26/0626; G01N 21/95684; B23K 26/705; B23K 26/26; B23K 26/032

(57) ABSTRACT

A method for manufacturing metal strip comprises abutting at least two metal strips to form a abutment interface between each other, then welding the metal strips along the abutment interface by a laser light to form a weld pass with a welding penetration depth between the metal strips, and a reflected light is reflected from the weld pass, and finally receiving the reflected light by a spectrometer which can determine the welding penetration depth according to the reflected light spectrum. A welding parameter can be selectively adjusted according to the welding penetration depth to correct the welding penetration depth in real time, and the follow-up weld pass can conform to the specification for decreasing weld defective ratio.

### FIELD OF THE INVENTION

This invention relates to a method for manufacturing metal strip, particularly relates to a method for manufacturing metal strip which can detect welding penetration depth by spectrometer to correct welding penetration depth in real time.

### BACKGROUND OF THE INVENTION

In order to prevent the active components from damage caused by huge current surge, electric resistance element is usually installed in the power control module of precise electronic products for voltage sensing and stabilizing. And those skilled in the art usually manufacture heterogeneous metal strip by high energy electron beam welding, because high energy electron beam welding has some advantages, like high aspect ratio of welding fusion zone and small heat-affected zone, and the heterogeneous metal strip can be cut equidistantly to form low resistance elements.

However, electron beam welding has to be performed in vacuum chamber and the equipment cost is high. In addition, electron beam welding is difficult to detect welding penetration depth of weld pass in real time for adjusting welding parameters, and welding quality only can be detected by metallurgical analysis of weld pass when the welding is finished, so product yield improvement is not easy. Furthermore, the metal strip after electron beam welding must be trimmed by laser cutting or machine grinding for correct resistor is main issue for those skilled in the art.

### SUMMARY

The primary object of the present invention is to provide a method for manufacturing metal strip, wherein a weld pass is formed by laser welding metal strip, and a spectrometer is adapted to detect the spectrum of reflected light which is reflected from the weld pass. So welding penetration depth of the weld pass can be detected and corrected in real time for decreasing welding defective proportion efficiently.

A method for manufacturing metal strip comprises abutting at least two metal strips, wherein a abutment interface is formed between the metal strips; welding the metal strips by a laser light, wherein the laser light is applied to the abutment interface and welds the metal strips along the abutment interface to form a weld pass with a welding penetration depth between the metal strips, and a reflected light is reflected from the weld pass; and receiving the reflected light by a spectrometer, wherein the spectrometer determines the welding penetration depth according to the reflected light spectrum, and a welding parameter is adjusted selectively according to the welding penetration depth for correcting the welding penetration depth in real time.

The present invention uses the laser light to weld those metal strips, so the weld pass has some advantages, like small heat-affected zone, higher aspect ratio of welding fusion zone and smooth surface. And the present invention uses the spectrometer to detect the spectrum of the reflected light for determining the welding penetration depth, and the welding parameter can be selectively adjusted in real time to correct the welding penetration depth when the welding penetration depth is out of the specification. Therefore, the welding penetration depth will not be out of the specification continuously.

### DESCRIPTION OF THE DRAWINGS

FIG. 1 is a flow chart illustrating a method for manufacturing metal strip in accordance with an embodiment of the present invention.

FIG. 2 is a perspective diagram illustrating a feeding platform in accordance with the embodiment of the present invention.

FIG. 3 is a lateral view diagram illustrating the feeding platform in accordance with the embodiment of the present invention.

FIG. 4 is a diagram illustrating the method for manufacturing metal strip in accordance with the embodiment of the present invention.

### DETAILED DESCRIPTION OF THE INVENTION

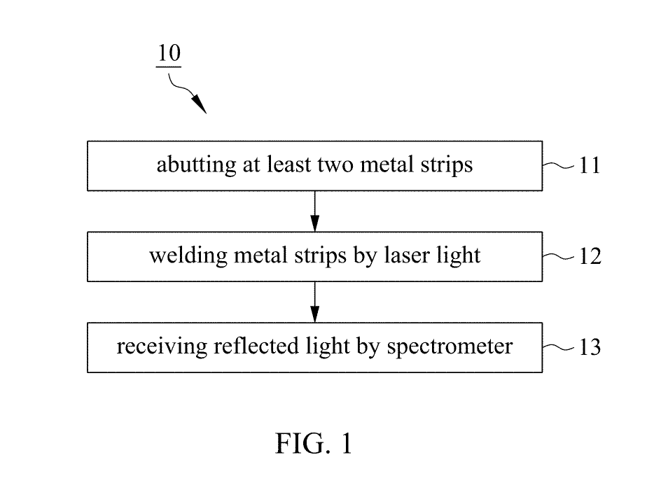

With reference to FIG. 1, a method for manufacturing metal strip 10 comprises step 11 of abutting at least two metal strips, step 12 of welding metal strips by laser light and step 13 of receiving reflected light by spectrometer.

With reference to FIGS. 1, 2 and 3, a plurality of metal strips M are placed on a surface 100a of a feeding platform 100 in the step 11 of abutting at least two metal strips, the adjacent metal strips M are abutted with each other, and an abutment interface G is formed between each other.

Before step 11, a grinder (not shown in drawing) is preferably adapted to grind the surface and lateral side of the metal strips M for removing burr and oxide. And grinding the surface of the metal strips M can make the thickness of the metal strips M being consistent, and grinding the later side of the metal strips M can make the width of the metal strips M being conformed to the specification.

The metal strips M can be made of same or different materials. The metal strips M involve a first metal strip M1, a second metal strip M2 and a third metal strip M3 in this embodiment, wherein the first metal strip M1 is located between the second metal strip M2 and the third metal strip M3. The first metal strip M1 can be made of copper (Cu) alloy, manganese (Mn) alloy, molybdenum (Mo) alloy, nickel (Ni) alloy, chromium (Cr) alloy or tin (Sn) alloy, and the second metal strip M2 and the third metal strip M3 can be made of copper (Cu), aluminum (Al) or silver (Ag). In this embodiment, the first metal strip M1 is made of manganese-copper (Mn—Cu) alloy, and the second metal strip M2 and the third metal strip M3 are made of copper (Cu).

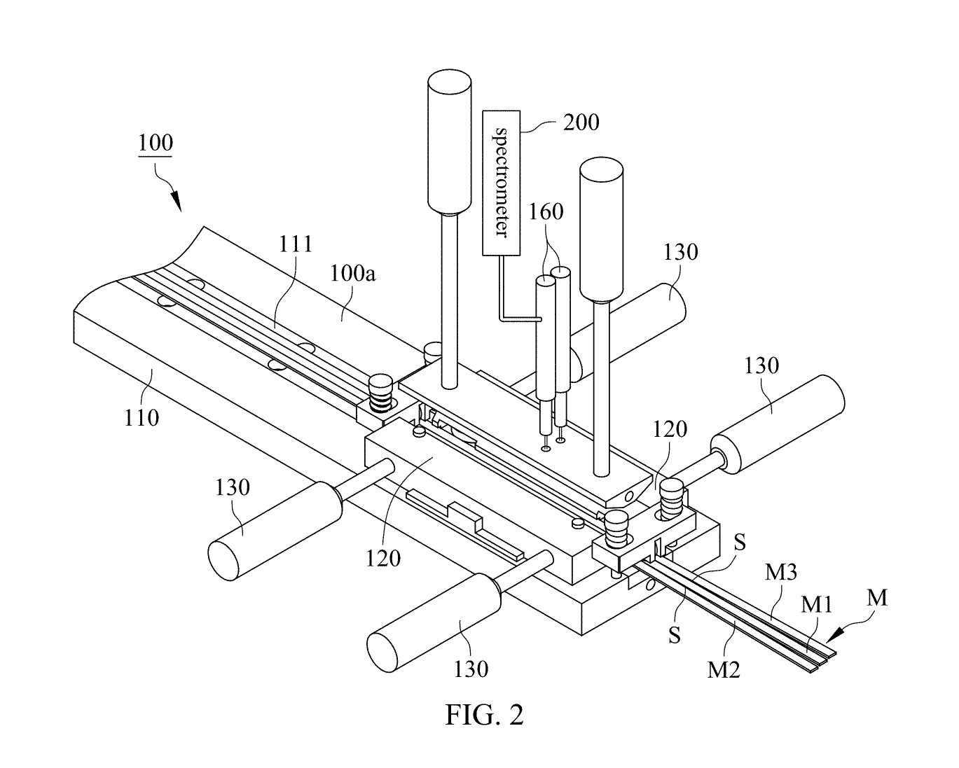

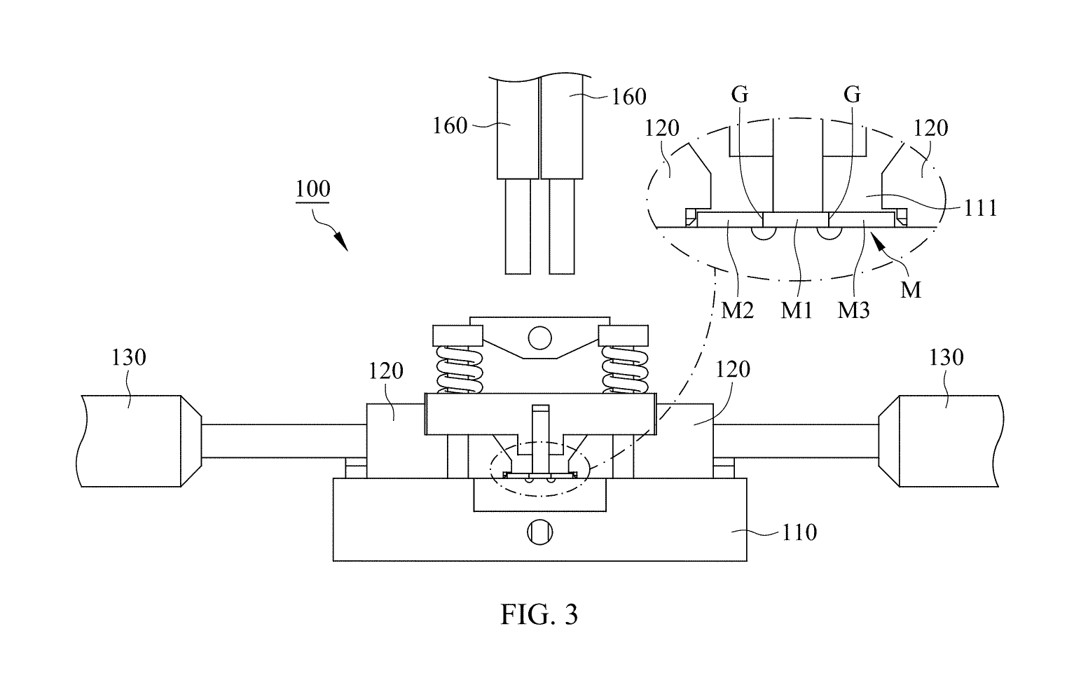

With reference to FIGS. 2 and 3, the feeding platform 100 includes a base 110, two limiting components 120 and at least two driving components 130 preferably, wherein the surface 100a of the feeding platform 100 is the surface of the base 110, and the limiting components 120 and the driving components 130 are placed on the surface of the base 110. The base 110 has a transport pathway 111 which is located between the limiting components 120, and the metal strips M are transported simultaneously along the transport pathway 111. The driving components 130 are motor, oil cylinder or pneumatic cylinder, and each of the driving components 130 can push one of the limiting components 120 moving toward the other limiting component 120 to clamp the metal strips M for tight abutment. Hence, the driving components 130 are adapted to adjust the width of the transport pathway 111 for satisfying different width specifications of the metal strips M.

With reference to FIGS. 1, 3 and 4, the metal strips M are welded by a laser light L1 in step 12 of welding metal strips by laser light. The laser light L1 is applied to the abutment interface G and welds the metal strips M along the abutment interface G to form a weld pass W between the metal strips M, and a reflected light L2 is reflected from the weld pass W during step 12. Preferably, the feeding platform 100 further includes a light source 140 and an energy-share module 150, wherein the light source 140 emits a laser beam to the energy-share module 150, and the energy-share module 150 split the laser beam into two laser lights L1. The laser lights L1 are respectively applied to the abutment interface G between the metal strips M, wherein the laser light L1 is multiple-mode laser, particularly is Nd:YAG laser or optical fiber laser.

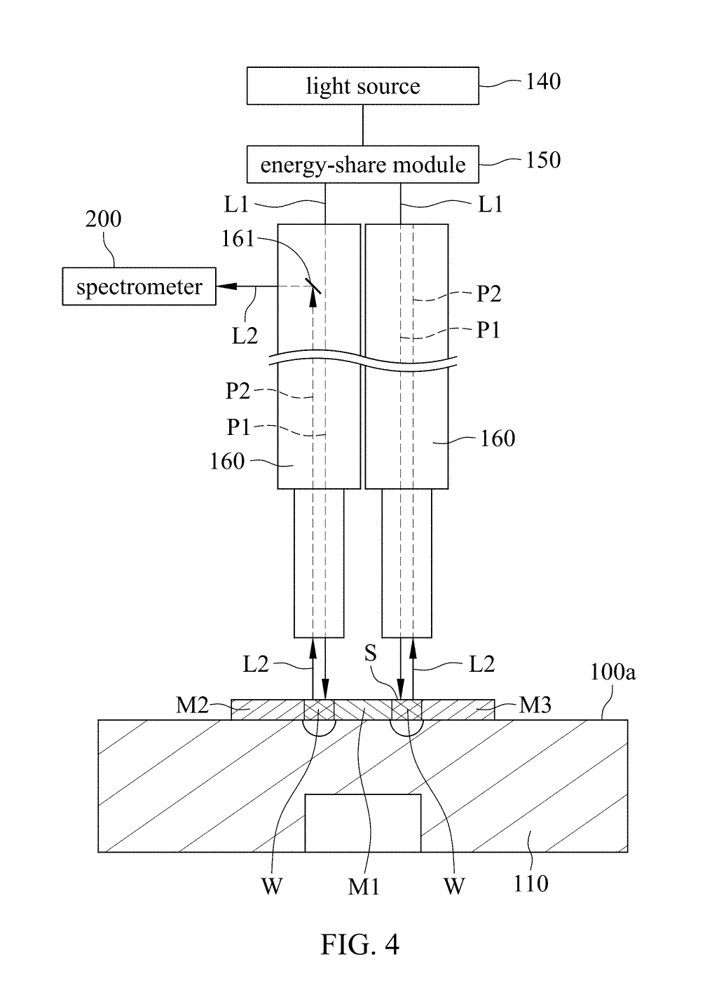

With reference to FIGS. 2, 3 and 4, the feeding platform 100 further includes at least one laser welding head 160 which installed above the surface 100a of the feeding platform 100, particularly installed above the metal strips M. The laser light L1 pass through the laser welding head 160 to apply to the abutment interface G when the metal strips M moving along the transport pathway 111 simultaneously and passing from below the laser welding head 160. With reference to FIG. 4, the laser light L1 emits to the abutment interface G along an emitting path P1 from the laser welding head 160 for welding the metal strips M. In this embodiment, the emitting path P1 and a trace S of the abutment interface G are vertical substantially (means the incident angle of the laser light L1 is substantially zero), so the reflected light L2 is reflected from the weld pass W by substantially vertical reflection (means the reflection angle of the reflected light L2 is also substantially zero) and into a spectrometer 200 along a reflecting path P2. The emitting path P1 and the reflecting path P2 are substantially parallel in the laser welding head 160 in this embodiment. In other embodiments, the incident angle of the laser light L1 and the reflection angle of the reflected light L2 can be adjusted according to the configuration of the light source 140, the energy-share module 150 and the spectrometer 200.

With reference to FIGS. 1 and 4, the reflected light L2 is received by the spectrometer 200 in step 13 of receiving reflected light by spectrometer, wherein the spectrometer 200 can determine a welding penetration depth of the weld pass W according to the spectrum of the reflected light L2. The spectrometer 200 is selected based on the wavelength range of the laser light L1 and able to receive the reflected light L2 with specific wavelength range generated from the laser light L1. In this embodiment, the spectrometer 200 is adapted to receive the reflected light L2 with wavelength between 800 and 900 nm for optical fiber laser. The spectrometer 200 is but not limit to AvaSpec-Fast, which the highest frequency is 5000 Hz and the acceptable wavelength is between 200 and 1160 nm.

The spectrometer 200 can detect the welding penetration depth of the weld pass W according to the wavelength variation in the spectrum of the reflected light L2. The spectrometer 200 will feedback a signal to the feeding platform 100 when the welding penetration depth of the weld pass W does not conform to the specification, and the feeding platform 100 can selectively adjust a welding parameter based on the welding penetration depth of the weld pass W to correct the welding penetration depth of the weld pass W in real time for specification conformance. Preferably, the scan speed of the spectrometer 200 is about 0.2 ms, so the spectrometer 200 can feedback the signal to the feeding platform 100 for adjusting the welding parameter in real time. And the weld parameter is power of the laser light L1 or the feeding speed of the metal strips M which is same with the speed of the metal strips M passing from below the laser welding head 160. Based on the feedback signal from the spectrometer 200, the power of the laser light L1 is adjustable between 1000 and 2000 W and the feeding speed of the metal strips M is adjustable between 1000 and 2000 mm/min for manufacturing the weld pass W with the welding penetration depth conforming to the specification.

The spectrometer 200 will feedback the signal to the feeding platform 100 to improve the power of the laser light L1 or slow down the feeding speed of the metal strips M when the welding penetration depth of the weld pass W is below the specification, hence the welding penetration depth of the weld pass W can be increased immediately. On the contrary, the spectrometer 200 will feedback the signal to the feeding platform 100 to decrease the power of the laser light L1 or enhance the feeding speed of the metal strips M when the welding penetration depth of the weld pass W is higher than the specification, so the welding penetration depth of the weld pass W can be decreased immediately.

With reference to FIG. 4, the laser welding head 160 includes a reflector 161 preferably, wherein the reflector 161 is installed in the inside of the laser welding head 160 and located on the reflecting path P2. The reflector 161 is adapted to reflect the reflected light L2 into the spectrometer 200 which is located on the side of the laser welding head 160.

Preferably, the welded metal strip will be transported to another grinder (not shown in drawing) after step 13, the grinder is used to grind and smooth the welded metal strip for follow-up furling.

The present invention can adjust the welding parameter of the feeding platform 100 and correct the welding penetration depth of the weld pass W in real time by the spectrometer 200 which can detect the welding penetration depth of the weld pass W. Hence, the present invention can detect the welding quality during welding, and the welding quality obtained according to metallurgical analysis of the weld pass W after welding whole roll of metal strip is not necessary. The welding quality of the welded metal strip manufactured by the present invention is excellent, and the welded metal strip is adapted to produce the resistance element with specific resistivity by cutting equidistantly, wherein the resistance element with specific resistivity can be applied to power control module of precise electronic products.

While this invention has been particularly illustrated and described in detail with respect to the preferred embodiments thereof, it will be clearly understood by those skilled in the art that is not limited to the specific features shown and described and various modified and changed in form and details may be made without separation from the spirit and scope of this invention.

What is claimed is:

1. A method for manufacturing metal strip comprising:
abutting at least two metal strips, wherein a abutment interface is formed between the metal strips;
welding the metal strips by a laser light, wherein the laser light is applied to the abutment interface and welds the metal strips along the abutment interface to form a weld pass with a welding penetration depth between the metal strips, and a reflected light is reflected from the weld pass; and
receiving the reflected light by a spectrometer, wherein the spectrometer determines the welding penetration depth according to the reflected light spectrum, and a welding parameter is adjusted selectively according to the welding penetration depth for correcting the welding penetration depth in real time.

2. The method for manufacturing metal strip in accordance with claim 1, wherein the laser light emits to the abutment interface along an emitting path, and the emitting path and a trace of the abutment interface are vertical substantially.

3. The method for manufacturing metal strip in accordance with claim 2, wherein the reflected light is reflected into the spectrometer from the weld pass along a reflecting path, and the emitting path and the reflecting path are substantially parallel.

4. The method for manufacturing metal strip in accordance with claim 3, wherein a reflector is installed on the reflecting path and adapted to reflect the reflected light into the spectrometer.

5. The method for manufacturing metal strip in accordance with claim 1, wherein the welding parameter is power of the laser light.

6. The method for manufacturing metal strip in accordance with claim 1, wherein the welding parameter is feeding speed of the metal strips.

7. The method for manufacturing metal strip in accordance with claim 1, wherein the laser light is Nd:YAG laser or optical fiber laser.

8. The method for manufacturing metal strip in accordance with claim 1, wherein the laser light is optical fiber laser, and the spectrometer is adapted to receive the reflected light with wavelength between 800 and 900 nm.
